(19) United States
(12) Patent Application Publication
(10) Pub. No.: US 2019/0036895 A1
(43) Pub. Date: Jan. 31, 2019

(54) DATA DISTRIBUTION OVER NODAL ELEMENTS

(71) Applicant: The Maidsafe Foundation, Ayr (GB)

(72) Inventor: David Irvine, Barr (GB)

(21) Appl. No.: 16/149,389

(22) Filed: Oct. 2, 2018

Related U.S. Application Data
(63) Continuation-in-part of application No. 14/659,390, filed on Mar. 16, 2015.

(51) Int. Cl. H04L 29/06; H04L 9/08; H04L 12/861

(52) U.S. Cl. CPC H04L 63/0485; H04L 9/0877; H04L 2209/56; H04L 49/9057; H04L 63/123

(57) ABSTRACT

A data communication system to provide secure data communication. The data communication system comprises an arrangement of elements coupled via communication links, wherein the elements comprise one or more user devices, one or more nodal elements or one or more servers, and/or one or more routers. The data communication system is operable to communicate data therein in a format which comprises data chunks which have been encrypted and obfuscated and are defined by one or more data maps, wherein the data communication system is configured to categorize the elements into one or more trusted elements and one or more untrusted elements, to receive votes from the one or more trusted elements to compute a consensus for verifying one or more transaction events. Optionally, the data communication system uses the received votes from the one or more trusted elements to compute a consensus for verifying a reliability of one or more elements of the public/non-permissioned network of the data communication system, wherein the consensus from the one or more trusted elements is used to disconnect selectively one or more unreliable elements from the data communication system.

### TECHNICAL FIELD

The present disclosure relates to data communication systems and methods to provide secure data communication. Moreover, the present disclosure concerns methods for (of) storing and communicating data in the data communication system where member nodes join or leave in a dynamic manner. Furthermore, the present disclosure relates to computer program products comprising a non-transitory computer-readable storage medium having computer-readable instructions stored thereon, the computer-readable instructions being executable by a computerized device comprising processing hardware to execute aforementioned methods.

### BACKGROUND

Generally, users perform backup of their data from their user devices onto data storage media of one or more remote computing nodes, such that user data is not lost in an event that the user devices are lost, stolen or malfunction. One form of centrally storing a given user's local data includes contemporary “cloud computing” arrangements. Data services are provided from the one or more remote computing nodes. The data services available include, for example, on-line purchasing and retailing, wherein details of user retail searching choices, purchase history and various other information are stored at the one or more computing nodes. Authorizations to add, delete, analyze, or disseminate user data stored in the one or more remote computing nodes rest with operators of the one or more remote computing nodes. Recently, “data mining”, personal privacy and protection of data have become major political issues, and users are increasingly demanding that stricter controls regarding dissemination of their data be provided by the operators. Moreover, a large commercial service industry has also arisen around mining and selling analyses of user data via, for example, contemporary social media websites, cloud-based e-mail services, etc. However, such data mining is potentially susceptible to misuse. For example, mined data may be used for purposes of blackmail or theft.

Problems arising in centralized computing, for example, in the aforesaid “cloud computing” arrangement, demand a need for distributed computing. In distributed computing, an individual user device determines a degree of data mining that is executed, rather than remote computing servers of data systems. Within a technical field of distributed computing, individual user devices in a de-centralized network must be able to agree a state without a central authority, for example, the remote computing servers, being employed, as aforementioned. Furthermore, the individual user devices in the de-centralized network should be able to agree to a state even if some of the user devices or the remote computing nodes are malicious. Furthermore, the individual devices must be able to agree to a state when a network, for example a Peer-to-Peer (P2P) network, allows devices to leave and join the network in a flexible dynamic manner. Moreover, such P2P networks can also potentially become very extensive, for example including thousands or even millions of nodes. However, when such peer-to-peer networks are used for transaction of resources, for example data representative of real physical resources (for example, sale and purchase of real physical objects such as houses, real estate, manufactured products, foodstuffs and so forth), or abstract resources (for example, data representative of a cryptocurrency (for example Bitcoin®) which in turn are tradeable for real physical resources), a technical problem arises with verification of data transactions occurring within the peer-to-peer networks. Known existing state-of-the-art consensus mechanisms have drawbacks with regard to their complexity, their lack of security and their lack of scalability. Asynchronous consensus/node ordering mechanisms represent a potential solution to the aforesaid drawbacks within non-dynamic/permissioned networks, but fail to do so in public/non-permissioned networks; the present disclosure seeks to address such limitations of known technical approaches. Thus, the present disclosure seeks to provide a technically elegant solution to aforementioned problems of known art, and enables given individual user devices to agree a state within a network that includes a dynamically changing numbers of user devices involved.

### SUMMARY

The present disclosure seeks to provide a data communication system for secure data communication, wherein the data communication system allows for member nodes to be added and/or removed in a flexible dynamic manner.

Optionally, the present disclosure discloses a data communication system to provide storage of user data in a form of encrypted and/or obfuscated data chunks, to provide an enhanced degree of data security.

According to a first aspect, there is provided a data communication system that provides, when in operation, secure data communication,

wherein the data communication system comprises an arrangement of elements coupled via communication links, wherein the elements comprise one or more user devices, one or more nodal elements or one or more servers, and/or one or more routers,
wherein the data communication system, when in operation,
communicates data therein in a format which comprises data chunks which have been encrypted and obfuscated and are defined by one or more data maps, and
categorizes the elements into one or more trusted elements and one or more untrusted elements, wherein a trust verification arrangement
determines whether a given element is a trusted element or an untrusted element; and
receives votes from the one or more trusted elements to compute a consensus for verifying one or more transaction events, wherein computing the consensus comprises using an asynchronous consensus/node ordering mechanism that functions within a public/non-permissioned network wherein elements are temporally dynamically changing.

Optionally, the data communication system comprises a ledger arrangement that records, when in operation, transaction events, and wherein the data communication system comprises a voting arrangement that receives the votes from the trusted nodes to compute the consensus for verifying one or more transaction events to be recorded or already recorded on the ledger arrangement.

Optionally, the data communication system, when in operation to store data:

divides user data into one or more data chunks that are then encrypted and/or obfuscated; and
stores the one or more encrypted and/or obfuscated data chunks at the one or more nodal elements or one or more servers, wherein locations of the one or more nodal elements or one or more servers, whereat the one or more encrypted and/or obfuscated data chunks are stored, are recorded in at least one data map of the one or more data maps; and
wherein the data communication system, when in operation, retrieves the user data from the one or more encrypted and/or obfuscated data chunks by:
retrieving the one or more encrypted and/or obfuscated data chunks at the one or more nodal elements or one or more servers, wherein locations of the one or more nodal elements or one or more servers, whereat the one or more encrypted and/or obfuscated data chunks are stored, are recorded in the at least one data map of the one or more data maps; and
applying decryption to the data chunks and/or de-obfuscating the data chunks by swapping data between the data chunks, and combining the plurality of the decrypted and/or de-obfuscated data chunks to generate the user data.

Optionally, the data communication system is a publicly-accessible network, wherein

the elements are able to disconnect from the publicly-accessible network and/or
the elements are able to connect to the publicly-accessible network as a function of time, and
wherein the given element connecting to the publicly-accessible network is initially assumed by the data communication system to be an untrusted element until the trust verification arrangement transitions the given node from being assumed to be the untrusted element to become a trusted element of the data communication system.

Optionally, the trust verification arrangement is implemented to access a distributed database, and the trust verification arrangement uses the distributed database to:

determine a speed with which the given element is able to receive information related to transaction events occurring within the data communication system;
determine a degree to which the given element has access to information indicative of events associated with transaction events occurring within the data communication system;
determine a previous historical performance of the given element when earlier verifying the one or more transaction events occurring within the data communication system; and
determine an age of the given element and a reputation parameter that the given element has in respect of other elements of the data communication system.

Optionally, the data communication system is implemented such that the one or more nodal elements or one or more servers at the locations, whereat the one or more encrypted and/or obfuscated data chunks are stored,

maintain, when in operation, multiple copies of their respective encrypted and/or obfuscated data chunks, and
regenerate, when in operation, from uncorrupted copies of the encrypted and/or obfuscated data chunks one or more replacement encrypted and/or obfuscated data chunks to replace any copy of the encrypted and/or obfuscated data chunks which have been corrupted.

According to a second aspect, there is provided a method for (of) operating a data communication system to provide secure data communication, wherein the method includes:

arranging for the data communication system to comprise an arrangement of elements coupled via communication links, wherein the elements comprise one or more user devices, one or more nodal elements or one or more servers, and/or one or more routers,
wherein the method further comprises:
operating the data communication system to communicate data therein in a format which comprises data chunks which have been encrypted and obfuscated and are defined by one or more data maps, and
wherein the method of operating the data communication system comprises:
categorizing the elements into one or more trusted elements and one or more untrusted elements, wherein a trust verification arrangement determines whether a given element is a trusted element or an untrusted element; and
receiving votes from the one or more trusted elements to compute a consensus for verifying one or more transaction events, wherein computing the consensus comprises using (for example, combining) an asynchronous consensus/node ordering mechanism that functions within a public/non-permissioned network wherein elements are temporally dynamically changing.

Optionally, the method includes:

arranging for the data communication system to comprise a ledger arrangement that records transaction events, and wherein the method further comprises arranging for a voting arrangement to receive the votes from the trusted nodes to compute the consensus for verifying one or more transaction events to be recorded or already recorded on the ledger arrangement.

Optionally, the method for (of) operating the data communication system, for storing data, comprises:

dividing user data into one or more data chunks that are then encrypted and/or obfuscated; and
storing the one or more encrypted and/or obfuscated data chunks at the one or more nodal elements or one or more servers, wherein locations of the one or more nodal elements or one or more servers, whereat the one or more encrypted and/or obfuscated data chunks are stored, are recorded in at least one data map of the one or more data maps; and wherein the method further comprises:
operating the data communication system to retrieve the user data from the one or more encrypted and/or obfuscated data chunks by:
retrieving the one or more encrypted and/or obfuscated data chunks at the one or more nodal elements or one or more servers, wherein locations of the one or more nodal elements or one or more servers, whereat the one or more encrypted and/or obfuscated data chunks are stored, are recorded in the at least one data map of the one or more data maps;
applying decryption to the data chunks and/or de-obfuscating the data chunks by swapping data between the data chunks, and
combining the plurality of the decrypted and/or de-obfuscated data chunks to generate the user data.

Optionally, the data communication system is a publicly-accessible network wherein

the elements are able to disconnect from the publicly-accessible network and/or
the elements are able to connect to the publicly-accessible network as a function of time, and
wherein the given element connecting to the publicly-accessible network is initially assumed by the method of operating the data communication system to be an untrusted element until the trust verification arrangement transitions the given node from being assumed to be the untrusted element to become a trusted element of the data communication system.

Optionally, the method includes implementing the trust verification arrangement to access a distributed database, and arranging for the trust verification arrangement to use the distributed database for:

determining a speed with which the given element is able to receive information related to transaction events occurring within the data communication system;
determining a degree to which the given element has access to information indicative of events associated with transaction events occurring within the data communication system;
determining a previous historical performance of the given element when earlier verifying the one or more transaction events occurring within the data communication system; and
determining an age of the given element and a reputation parameter that the given element has in respect of other elements of the data communication system.

Optionally, the method for (of) operating the data communication system includes arranging for the one or more nodal elements or one or more servers at the locations, whereat the one or more encrypted and/or obfuscated data chunks are stored,

to maintain, when in operation. multiple copies of their respective encrypted and/or obfuscated data chunks, and
to regenerate, when in operation, from uncorrupted copies of the encrypted and/or obfuscated data chunks one or more replacement encrypted and/or obfuscated data chunks to replace any copy of the encrypted and/or obfuscated data chunks which have been corrupted.

According to a third aspect, there is provided a computer program product comprising a non-transitory computer-readable storage medium having computer-readable instructions stored thereon, the computer-readable instructions being executable by a computerized device comprising processing hardware to execute a method for (of) operating a data communication system to provide secure data communication, wherein the method comprises arranging for the data communication system to comprise an arrangement of elements coupled via communication links, wherein the elements comprise one or more user devices, one or more nodal elements or one or more servers, and/or one or more routers, wherein the method comprises:

operating the data communication system to communicate data therein in a format which comprises data chunks which have been encrypted and obfuscated and are defined by one or more data maps, categorizing the elements into one or more trusted elements and one or more untrusted elements, wherein a trust verification arrangement determines whether a given element is a trusted element or an untrusted element; and
receiving votes from the one or more trusted elements to compute a consensus for verifying one or more transaction events, wherein computing the consensus comprises combining an asynchronous consensus/node ordering mechanism that functions within a public/non-permissioned network wherein elements are temporally dynamically changing.

Optionally, the computer program product is arranged such that the method comprises using a ledger arrangement for recording transaction events, and wherein the method comprises arranging for a voting arrangement to receive the votes from the trusted nodes to compute the consensus for verifying one or more transaction events to be recorded or already recorded on the ledger arrangement.

Optionally, the computer program product is arranged such that the method comprises: dividing user data into one or more data chunks that are then encrypted and/or obfuscated; and storing the one or more encrypted and/or obfuscated data chunks at the one or more nodal elements or one or more servers, wherein locations of the one or more nodal elements or one or more servers, whereat the one or more encrypted and/or obfuscated data chunks are stored, are recorded in at least one data map of the one or more data maps; and wherein the data communication system, when in operation, retrieves the user data from the one or more encrypted and/or obfuscated data chunks by:

retrieving the one or more encrypted and/or obfuscated data chunks at the one or more nodal elements or one or more servers, wherein locations of the one or more nodal elements or one or more servers, whereat the one or more encrypted and/or obfuscated data chunks are stored, are recorded in the at least one data map of the one or more data maps;
applying decryption to the data chunks and/or de-obfuscating the data chunks by swapping data between the data chunks, and
combining the plurality of the decrypted and/or de-obfuscated data chunks to generate the user data.

Optionally, the computer program product is arranged such that, in the method for (of) operating the data communication system, the data communication system is a publicly-accessible network wherein:

the elements are able to disconnect from the publicly-accessible network and/or
the elements are able to connect to the publicly-accessible network as a function of time.

Optionally, the computer program product is arranged such that, in the method, the given element connecting to the publicly-accessible network is initially assumed by the method for (of) operating the data communication system to be an untrusted element until the trust verification arrangement transitions the given node from being assumed to be the untrusted element to become a trusted element of the data communication system.

Optionally, the computer program product is arranged such that, in the method of operating the data communication system, the trust verification arrangement is implemented to access a distributed database, and the trust verification arrangement uses the distributed database for:

determining a speed with which the given element is able to receive information related to transaction events occurring within the data communication system;

determining a degree to which the given element has access to information indicative of events associated with transaction events occurring within the data communication system;
determining a previous historical performance of the given element when earlier verifying the one or more transaction events occurring within the data communication system; and
determining an age of the given element and a reputation parameter that the given element has in respect of other elements of the data communication system.

Optionally, the computer program product is arranged such that the method of operating the data communication system is implemented such that the one or more nodal elements or one or more servers at the locations, whereat the one or more encrypted and/or obfuscated data chunks are stored, maintain multiple copies of their respective encrypted and/or obfuscated data chunks, and to regenerate from uncorrupted copies of the encrypted and/or obfuscated data chunks one or more replacement encrypted and/or obfuscated data chunks to replace any copy of the encrypted and/or obfuscated data chunks which have been corrupted.

The invention is of the advantage that the data communication system is able to verify every transaction event for its validity. No fraud event can occur in the data communication system as all the trusted nodes are voting for the asynchronous consensus. The problem associated with a public/non-permissioned network employed to implement the data communication system is that any node, which may possess threat, can join or leave the network. An example of such a network is the P2P network, where any node can leave or join the network in a flexible dynamic manner. The technical advantage associated with the present invention is that only trusted elements vote to make the consensus, to which all the elements agree, for verifying events occurring in the data communication.

The present disclosure is of advantage in that use of the data chunks that have been encrypted and obfuscated enables more secure communication and storage of information, for example to reduce a risk of third party eavesdropping and corruption of user data.

Furthermore, the present disclosure is of advantage in that the data communication system is able to provide a reliable transaction of data therein, despite nodes leaving and joining the system in a dynamically changing manner, for example where the nodes are coupled via a publicly-accessible data communication network.

### DESCRIPTION OF THE DIAGRAMS

Embodiments of the present disclosure will now be described, by way of example only, with reference to the following diagrams wherein:

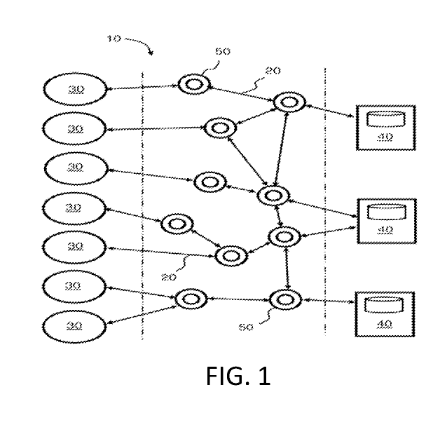

FIG. 1 is an illustration of a data system of the present disclosure including a plurality of elements coupled via data communication links;

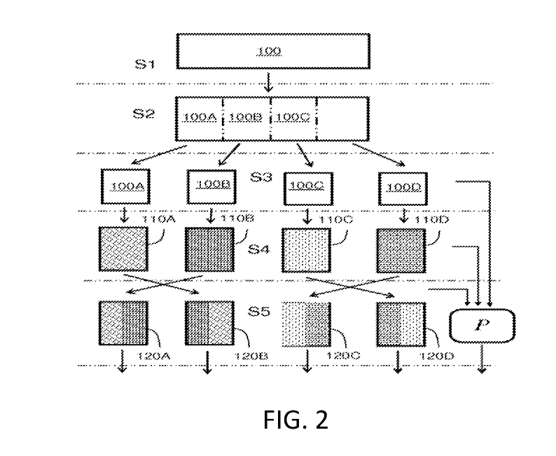

FIG. 2 is an illustration of steps of a method for (of) storing user data files in fragmented, encrypted and obfuscated form within a user-centric data system pursuant to the present disclosure;

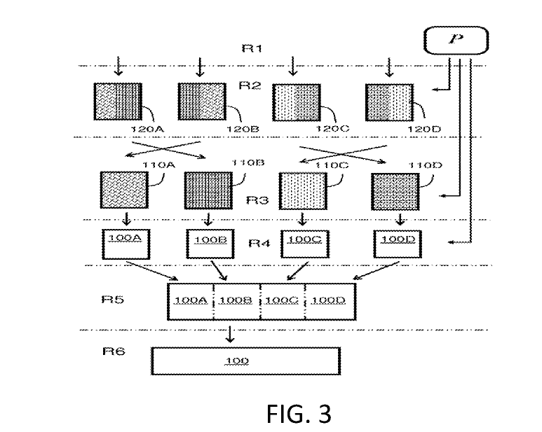

FIG. 3 is an illustration of steps of a method for (of) retrieving user data files in de-fragmented, decrypted and de-obfuscated form within a user-centric data system pursuant to the present disclosure;

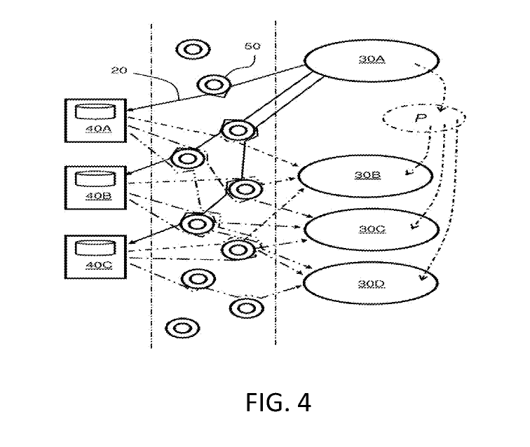

FIG. 4 is an illustration of a data system implemented in a user-centric manner for sharing data in an obfuscated encrypted manner between a plurality of user devices of the data system;

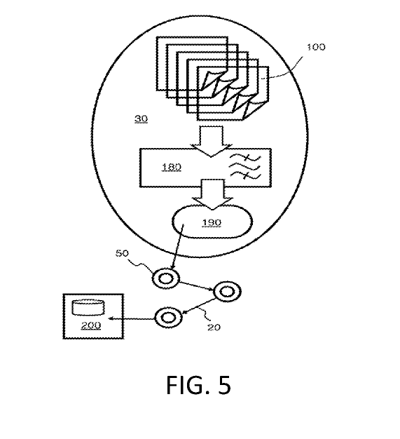

FIG. 5 is an illustration of generation of anonymous metadata files within the data system of FIG. 1 and their storage at one or more nodal elements for use by search engines;

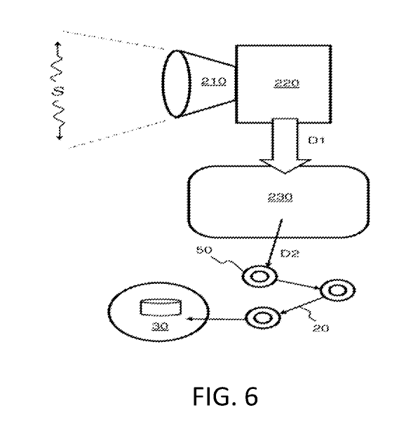

FIG. 6 is an illustration of use of the data system of FIG. 1 for remote sensing;

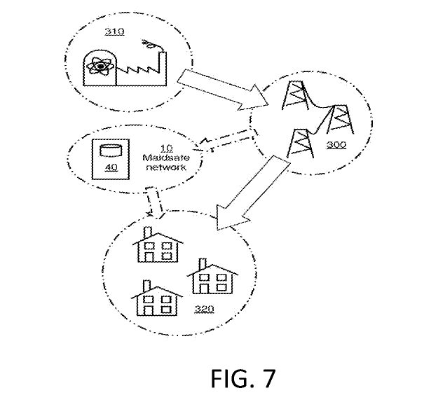

FIG. 7 is an illustration of use of the data system of FIG. 1 for remote control purposes;

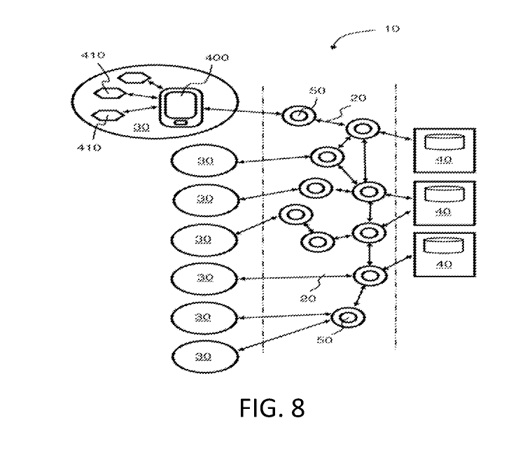

FIG. 8 is an illustration of a user device implemented as a relay device and one or more near-field satellite devices which are operable to communicate with the relay device, enabling a constellation of user-variable devices to be worn by an associated user; and

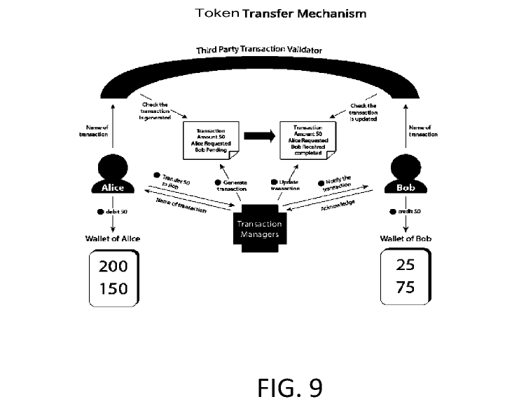

FIG. 9 is an illustration of the data system of FIG. 1 used for purposes of token distribution and management.

### DESCRIPTION OF EMBODIMENTS

In view of a present status of data management, for example in data communication networks such as the Internet®, there is a need for implementing a data communication system in a manner which is less susceptible to contemporary surveillance, and which is less likely to be abused by operators of servers of the data communication system storing user data, for example, in a “cloud computing” environment. Moreover, there is a need for a data communication system in which users determine a degree of data mining that is allowed to occur, rather than operators of servers of the data communication system. This need is not overcome by contemporary approaches to the Internet®, wherein “cloud computing” is greatly encouraged by parties benefiting commercially from data mining.

Referring to FIG. 1, a data communication system 10 includes an arrangement of elements coupled via communication links 20. The elements include, but are not limited to, one or more user devices 30, one or more nodal elements or one or more servers 40, and one or more routers 50. The Communication links 20 optionally include, but are not limited to, wireless links, optical fiber links, wired links and similar. The user devices 30 optionally includes, but is not limited to, personal computers, mobile telephones, smart phones, tablet computers and remote cameras.

In operation of the data communication system 10, user data is stored in data memory of the one or more user devices 30, as “local data”, in data storage media of one or more nodal elements 40 as “remote data”, or both of these.

In overview, the present disclosure is concerned with data systems that are more user-centric. The data systems employ a configuration of elements, such as that illustrated in FIG. 1, in a manner employing novel storage and access of user data. In an example user-centric data system pursuant to the present disclosure, a given user has one or more of his/her user data files substantially intact only at a computing device of the given user, and/or at one or more computing devices of one or more other users respectively which the given user has allowed to receive the user data files. Elsewhere in the user-centric data system, for example at the one or more nodal elements 40, the user's data is stored in a fragmented, encrypted and obfuscated form. A record of data fragmentation, encryption and obfuscation applied to each of the data fragments is recorded in an encrypted data map to which only the given user has access, or to one or more other parties to which the given user has granted permission. Due to a computational infeasibility, an unauthorized third party cannot reconstitute or regenerate the given user's data files from the fragmented, encrypted and obfuscated form to mine data, in contradistinction to known data systems in which user data is stored intact in external servers of a data network, as in contemporary “cloud computing”.

The data communication system 10, when in operation, provides a secure-access-for-everyone (SAFE) network, for example by way of its peer-to-peer (P2P) decentralized data and communications network. Moreover, the data communication system 10 provides, in operation, a secure and anonymous network that is implemented, at least in part, via spare computing resources from its users.

Data fragmentation, encryption and obfuscation will next be described with reference to FIG. 2. In a step S1, a given user generates a data file denoted by 100. The data file 100 exists locally within a computing device of the given user, for example, in a personal computer (PC), a tablet computer, a smart phone, a smart wrist-worn device, etc. In an example embodiment of the disclosure, the data file 100 exists only at a specific user software layer of a software operating system of the computing device of the given user. This measure prevents spyware from, unbeknown to the given user, executing at a different software layer of the user's computing device relative to the specific user software layer and gaining access to the data file 100.

In a step S2, as shown in FIG. 2, the data file 100 is partitioned, namely fragmented, to generate a plurality of fragments. Whereas, for example, four fragments 100A, 100B, 100C, 100D are depicted in FIG. 2, other numbers of fragments are feasible. In one example, the fragments 100A, 100B, 100C, 100D are of mutually same sizes. Alternatively, in one example, the fragments 100A, 100B, 100C, 100D are of mutually different sizes. In a step S3, data indicative of a manner in which the data file 100 is partitioned into fragments is recorded in a parameter file denoted by “P”. In an embodiment, partitioning of the data file 100 is implemented using a function that is seeded, or “salted”, by one or more passwords provided by the given user.

In a step S4, the fragments produced from the step S3 are subjected to encryption to generate corresponding encrypted fragments. In an example, the fragments 100A, 100B, 100C, 100D are encrypted to generate corresponding encrypted data files 110A, 110B, 110C, 110D, respectively. During encryption of the fragments 100A, 100B, 100C, 100D to generate the encrypted data files 110A, 110B, 110C, 110D, data indicative of the encryption applied is also included in the parameter file denoted by “P”. In an example, a mutually identical encryption algorithm is employed to encrypt the fragments 100A, 100B, 100C, 100D to generate the encrypted data files 110A, 110B, 110C, 110D. In an example, mutually dissimilar encryption algorithms are employed to encrypt the fragments 100A, 100B, 100C, 100D to generate the encrypted data files 110A, 110B, 110C, 110D. In an example, a selection of the encryption algorithm employed to encrypt the fragments 100A, 100B, 100C, 100D to generate the encrypted data files 110A, 110B, 110C, 110D is implemented using a function which is seeded, or “salted”, by one or more passwords provided by the given user. Although four encrypted data files are described, it will be appreciated that other numbers of encrypted data files are optionally employed.

In a step S5, the encrypted data files 110A, 110B, 110C, 110D are subject to obfuscation. In an example, such obfuscation is achieved by swapping one or more bytes of data between the encrypted data files 110A, 110B, 110C, 110D, to generate corresponding obfuscated data files 120A, 120B, 120C, 120D respectfully. In an example, obfuscation is achieved using a simple logic function that is native to a data processor of the given user's computing device. For example, the simple logic function may include an XOR function. Data indicative of a manner in which the obfuscation is implemented is also included in the parameter file denoted by “P”. Although four obfuscated data files are described, it will be appreciated that other numbers of encrypted data files are optionally employed.

Subsequently, the parameter file P and the obfuscated data files 120A, 120B, 120C, 120D are stored on a data storage medium of the given user's computing device. Storage is optionally, for example, on an encrypted hard disc drive or a non-volatile solid-state data memory of the given user's computing device. In an example, the obfuscated data files 120A, 120B, 120C, 120D are stored on one or more nodal elements 40. The one or more nodal elements 40 store, when in operation, obfuscated data files 120 in multiple copies on the one or more nodal elements 40 and employ a majority voting system to detect and repair any errors arising in the obfuscated data files 120A, 120B, 120C, 120D. In an example, the parameter file P is stored on a different nodal element 40 relative to one or more nodal elements 40 storing obfuscated data files 120A, 120B, 120C, 120D. In an embodiment, the parameter file P is stored in an encrypted form, and is accessible to the given user with a password known to that given user.

Recovery of a data file from the one or more elements 40 of the system 10 is next described with reference to FIG. 3. In a first step R1, the given user loads or otherwise recovers the parameter file P, which is stored in an encrypted state either on the given user's computing device and/or at a nodal element 40 of the data communicatuib network 10. Access to the parameter file P, which optionally functions as a data map, is achieved via use of at least one password known to the given user.

In a step R2, the parameter file P is decrypted and the locations of the obfuscated data files 120A, 120B, 120C, 120D are determined. The obfuscated data files 120A, 120B, 120C, 120D are recovered from their respective one or more nodal elements 40 and provided to the computing device of the given user. In a step R3, obfuscation processes used to generate the obfuscated data files 120A, 120B, 120C, 120D are determined from the parameter file P, and an inverse of these processes is then applied to the obfuscated data files 120A, 120B, 120C, 120D to regenerate corresponding encrypted data files 110A, 110B, 110C, 110D.

In a step R4, encryption processes that were used to generate the encrypted data files 110A, 110B, 110C, 110D are determined from the parameter file P, and inverses of such encryption processes are applied to the encrypted data files 110A, 110B, 110C, 110D to generate corresponding decrypted fragments 100A, 100B, 100C, 100D. In a step R5, a manner of fragmentation that was used to generate the fragments 100A, 100B, 100C, 100D is determined from the parameter file P, and an inverse of such fragmentation is then applied to the fragments 100A, 100B, 100C, 100D to regenerate the data file 100. Again, it will be appreciated that while four fragments have been shown in FIG. 3 for simplicity of illustration, other numbers of fragments can be employed. Optionally, the fragments are mutually identical in size. Optionally, alternatively, the fragments are mutually different in size.

It will be appreciated from the forgoing that the data file 100 only exists in a complete intact form within the computing device of the given user, and exists in a fragmented, encrypted and obfuscated form within the system 10, spatially remote from the given user's computing device. Methods associated with illustrations of FIG. 2 and FIG. 3 enable, for example, a secure and confidential data storage arrangement or data “repository” to be provided to the given user via the system 10 in a manner which substantially renders third-party eavesdropping impossible.

The system 10, when implemented in a user-centric manner pursuant to the present disclosure, is not limited to functioning merely as a box into which users are able to “drop” (namely store) their data files, as described in the foregoing, but is also the system 10, when in operation, supports sharing of data files between one or more other users. When data file sharing is performed, shared data files are only created, recovered or reconstituted at computing devices of users who have mutually agreed beforehand to share the data files. Nevertheless, the system 10 is also capable of broadcasting data files to all users of the system, namely publicly.

As illustrated in FIG. 4, a user of a user device 30A optionally shares his/her data file 100 by generating a corresponding parameter file P which is provided to other user devices 30A, 30B, 30C. The data file 100 is fragmented, encrypted and obfuscated, as aforementioned, and obfuscated encrypted fragments of the data file 100 are stored in a plurality of nodal elements 40A, 40B, 40C. The nodal elements 40A, 40B, 40C supply, when in operation, the obfuscated encrypted fragments to other user devices 30B, 30C, 30D, that regenerate the obfuscated, encrypted fragments into replicas of the data file 100 locally at these computing devices. The parameter file P is also provided to other user devices 30B, 30C, 30D to enable their computing devices to regenerate the replicas of data file 100. Optionally, the nodal elements 40A, 40B, 40C, for example data storage devices, are implemented in a proxy manner, namely the user devices 30B, 30C, 30D are only provided access to data storage devices, for example data servers, which mirror content of the nodal elements 40A, 40B, 40C to which the user device 30A has access.

The system 10 as implemented pursuant to FIG. 4 allows for secure and confidential file sharing, for example document sharing, between the user devices 30. Such a manner of operation may be implemented for document databases for large organizations whose offices and staff are spatially distributed. Moreover, such manners of operation are useful for activities which require a very high degree of confidentiality, for example for implementing legal firm management. Flows of obfuscated encrypted fragments along paths as depicted in FIG. 4 are optionally bi-directional, for example. Such a bi-directional operation is optionally implemented in real-time, allowing Voice Over Internet Protocol-type (VoIP)-type telephony and video conferencing to be achieved, without a risk of eavesdropping by unauthorized third parties. In an example, encrypted end-to-end messaging, both for e-mail and Short Messaging Service (SMS), is employed for such (VoIP)-type communication. In an example, during bi-directional real-time operation, the system 10 switches, when in operation, between any of a plurality of different parameter files P, such that if any third party were to manage to break into the bi-directional communication, the system 10 would be able to reconfigure itself frequently to thwart such eavesdropping. This switching of parameters may operate in a manner akin to “frequency-hopping” in conventional wireless communication systems.

In an embodiment, the system 10, when in operation, stores, recovers and shares its data files by employing obfuscated encrypted data fragments, and also generates other types of related user-defined metadata files which are made available to the system 10 for data mining purposes. Maintenance of the system 10, the nodal elements 40 and the data links 20, requires financial resources, which, in a case of the contemporary Internet®, is paid for by advertising and data mining activities. In the conventional Internet®, users have little control, if any, regarding an extent of data mining that is performed on user's data. The system 10 enables the user-defined metadata to be used for user-targeted advertising and data mining under the control of the users of the system 10. For example, some users of the system 10 will be eager to share their data as widely as possible, whereas other users will prefer to maintain a maximum degree of data security and confidentiality.

In view of the system 10 implemented in a user-centric manner pursuant to the present disclosure providing control to users of the user devices 30, in contradistinction, the conventional Internet® provides control to operators of servers thereof for deleting, analyzing and/or disseminating user data stored in the servers. However, the system 10 implemented in a user-centric manner is beneficially provided with a management function, for example for controlling use of the servers 40 (although it will be appreciated that the servers 40 of the system 10 are optionally not servers in a convention sense, but are beneficially implemented as SAFE elements), as well as methods of data repair when multiple copies of user fragments are stored at the servers 40, and majority-voting arrangement is employed to detect errors in data, without needing to be provided any information to what the user fragments pertain. In such a majority-voting arrangement, in an event that a given user's data fragment is stored in three copies, in an event that a first copy of the three copies deviates from a second copy and a third copy of the three copies which remain mutually similar, the first copy is determined by the system 10 to be in error. Such error is, for example, corrected in the system 10 by copying either the second copy or the third copy to overwrite the first copy. Other majority-voting arrangements are optionally employed to correct for data errors, for example parity-bit checking and so forth. If a given element of the system 10 implemented in a user-centric manner consistently results in data error, for example a given server 40 of the system 10 has developed a fault in one or more of its hard disc drives or has been infected by malware, the given element is recorded by the system 10 to be a bad element, and data provided from user devices 30 are directed to other elements, for example servers, which the system 10 has recorded as being reliable elements.

The system 10 implemented in a user-centric manner pursuant to the present disclosure optionally functions, when in operation, in a peer-to-peer (P2P) manner, namely user devices send their data fragments as user data into a communication network of the system 10 with an indication of a server 40 in which the user data is to be stored, and the network passes the user data therethrough in a peer-to-peer manner, until the data reaches the server 40 that has been specified. Optionally, the server 40 is defined by a URL as in conventional HTTP, although other types of communication protocol are optionally alternatively employed. Use of a peer-to-peer network configuration for the system 10 implemented in a user-centric manner pursuant to the present disclosure further places control away from any manager of the system 10 and more beneficially in favour (favor) of the users of the user devices 30.

When performing data transactions within a peer-to-peer network or similar type of diffuse network of elements, for example hosting a blockchain ledger, a need arises to achieve a decentralized consensus when performing data transactions that have potentially associated therewith significant financial or material consideration. Some known implementations of data communication networks have sought to try to address the aforementioned issue of decentralized consensus, but there are always some associated caveats concerning operation of the data communication networks.

Such a decentralized consensus can be handled by methods and/or processes such as a proprietary Paxos® algorithm or its variants. Under such methods and/or processes, one server of a database system is set up as a “leader”, and the leader decides the order of events; events (e.g., within multiplayer games) are forwarded to the leader, the leader chooses an ordering for the events, and the leader broadcasts that ordering to the other servers of the database system.

Such known approaches, however, use a server operated by a party (e.g., a central management server) trusted by users of the database system (e.g., game players). Accordingly, a need exists for methods and apparatus for a distributed database system that does not require a leader or a trusted third party to operate the database system. Thus, a technical problem addressed by the data communication system 10 pursuant to the present disclosure is how to maintain a high degree of security when the elements, including user devices 30, nodal elements or servers 40, and routers 50, leave or join the data communication system 10 in a temporally dynamic manner.

An important issue in data communication in relation to security is preventing unauthorized transactions occurring in the system 10. According to the embodiments of the present disclosure, as described in the following embodiments, such an important issue is resolved using consensus among trusted elements, as will be described in greater detail below.

The data communication system 10 combines an asynchronous consensus/node ordering mechanism that functions within a public/non-permissioned network where network members are dynamic, namely temporally leaving or joining the data communication system 10. Furthermore, the data communication system 10 is capable of working within an encrypted decentralized data and communications network that utilizes spare computing resources of users of the network. Additionally, the data communication system 10 can be used within any decentralized network requiring autonomous decision making including: decentralized software application (“app”) development platforms, corporate data networks, crypto currency and financial trading platforms, decentralized applications and gaming.

In order to provide the aforementioned aspects, there is provided a data communication system 10 to provide data communication and data storage, wherein the data communication system 10 comprises an arrangement of elements coupled via communication links 20. The elements comprise one or more user devices 30, one or more nodal elements or one or more servers 40, and one or more routers 50. The data communication system 10 communicates, when in operation, data therein in a format which includes data chunks which have been encrypted and obfuscated and are defined by one or more data maps, wherein the data communication system 10:

categorizes the elements into one or more trusted elements and one or more untrusted elements, wherein a trust verification arrangement determines whether a given element is a trusted element or an untrusted element; and
includes in the data transaction system a voting arrangement that receives votes from the trusted elements to compute a consensus for verifying one or more transaction events.

Optionally, the data communication system 10 includes a ledger arrangement that records transaction events implemented in respect of one or more resource elements; and arranges for the data transaction system to include the voting arrangement that receives votes from the trusted elements to compute the consensus for verifying one or more transaction events to be recorded or already recorded on the ledger arrangement.

A proof-of-stake protocol is optionally used in the data communication system 10. This proof-of-stake protocol allows the data communication system 10, functioning as a distributed database system, to converge correctly, for example, to a consensus, for example by employing voting amongst such honest active members or trusted elements. In some implementations, other members can join the system 10. The system 10 can be open without permissioning requirements (e.g. without members having to be invited to join by a founding member). Various criteria can be used within the system 10 to determine whether or not a given user, for example represented by an element of the system 10, is a trusted element or an untrusted element. When achieving a consensus for verifying a given transaction in a ledger of the data communication system 10, consensus voting amongst trusted members is employed in the system 10. Such criteria can, for example, relate to one or more of following:

(i) a speed with which a given element is able to receive information related to transaction events affecting the ledger of the data communication system 10;
(ii) a degree to which a given element has access to information indicative of events associated with transaction events occurring within the system 10; and
(iii) a previous historical performance of the given element when earlier verifying one or more transaction events affecting the ledger of the system 10.

When a given element or user couples to the system 10, the given element is initially treated as an untrusted element until its reliability can be established, wherein the untrusted element then becomes a trusted element and is then able to vote when providing a consensus regarding a validity of one or more entries made in the ledger of the system 10.

When a trusted element leaves the system 10, for example, disconnects from its data communication network, the trusted element either transitions to become an untrusted element and then decouples from the system 10, or the trusted element simply disappears from the system 10 on disconnection therefrom.

The example systems described above are expected to create and/or achieve an efficient convergence mechanism to achieve, in operation, a decentralized consensus, with eventual consensus being attained, for example when modifying a ledger blockchain when transacting data representative of cryptocurrencies, for example bitcoin.

According to another aspect of the present disclosure, there is provided a method used in the data communication system 10, wherein the method comprises arranging for the data communication system 10 to comprise an arrangement of elements coupled via communication links 20. The elements comprise one or more user devices 30, one or more nodal elements or one or more servers 40, and one or more routers 50. The method comprises operating the data communication system 10 to communicate data therein in a format which includes data chunks which have been encrypted and obfuscated and are defined by one or more data maps, wherein the method comprises:

categorizing the elements into one or more trusted elements and one or more untrusted elements, wherein a trust verification arrangement determines whether a given element is a trusted element or an untrusted element, and
including in the data transaction system a voting arrangement that receives votes from the trusted elements to compute a consensus for verifying one or more transaction events.

Optionally, the method comprises:

arranging for the data communication system 10 to include a ledger arrangement for recording transaction events implemented in respect of one or more resource elements; and
arranging for the data transaction system to include the voting arrangement that receives votes from the trusted elements to compute the consensus for verifying one or more transaction events to be recorded or already recorded on the ledger arrangement.

According to another aspect of the present disclosure, there is provided a computer program product comprising a non-transitory computer readable medium having computer readable instructions stored thereon, the computer readable instructions being executable by a computerized device comprising processing hardware to execute a method of the aforesaid aspect.

The system 10 is optionally operated to function in a peer-to-peer (P2P) manner, in which user devices send their data fragments as data into a communication network of the system 10 with an indication of a nodal element 40 in which the data is to be stored, and the network passes the data in a peer-to-peer manner, until the data reaches the specified nodal element 40. The nodal element 40 is optionally defined by a form of resource locator resembling a URL as in conventional HTTP. However, other types of communication protocol are optionally employed. Use of a peer-to-peer network configuration for the system 10 removes control from any manager of system 10 and in favour of the users of the devices 30.

In the data system 10, the data files 100 are only present in complete form at the devices 30 and otherwise exist only in a fragmented, obfuscated and encrypted manner elsewhere in the data system 10, as aforementioned. In an example embodiment, the user devices 30 optionally include one or more data filters 180, as illustrated in FIG. 6. In an example, the data filters 180 are optionally implemented as one or more executable software applications (“Apps”), which, when executed on computing hardware, process complete users' intact data files 100 at their user devices 30 and generate corresponding metadata files 190 which are communicated from the user devices 30 to one or more nodal elements 200 or 40 of the system 10. The data filters 180 are implemented to transmit selectively metadata files 190 therethrough, to one or more nodal elements 200. In an example, information content being selectively transmitted through the one or more data filters 180 are determined in accordance with parameters, such as keywords and thresholds, selected by the user, so that users are capable of controlling a degree of confidentiality provided by data system 10. As such, users of system 10 have control regarding a degree of data mining and analysis applied to their data files.

Metadata collected at the one or more nodal elements 200 or 40 of data system 100 are optionally used for targeted advertising purposes for sending advertisements to one or more of user devices 30. Advertisers engaging such advertising optionally pay a fee to support operating costs of the one or more nodal elements 40 storing obfuscated, encrypted fragments on behalf of user devices 30. A portion of an advertising fee is optionally paid to one or more users of system 10. Moreover, the metadata is optionally used for search engines which support operation of the data system 10.

Metadata is automatically generated in the user devices 30 by performing a statistical analysis of words occurring in one or more texts in the data files 100, and/or by performing image matching of images occurring in the data files 100 with reference images stored locally in the user devices 30 or downloaded from a remote database.

When the statistical analysis of words is performed, frequently occurring words are filtered out, and only less frequently occurring words are included in the corresponding metadata; and in such a manner, significant nouns, adjectives, adverbs and verbs are isolated for inclusion in the metadata. Thresholds applied in combination with the statistical analysis are user-controllable, thereby enabling users to control a degree of confidentiality of their data files 100 relative to corresponding metadata.

The system 10, when in operation, detects any unexpected data flows associated with activities of Spyware, Adware and other malware, and to alert users of devices 30 accordingly. Data flows occurring from the at least one user device in operation are monitored and detected discrepancies between size and/or temporal characteristics of the monitored data flows and expected size and/or temporal characteristics of data flows from the device are used to uncover malware.

The system 10 is suitable for use in remote sensing applications where confidentiality and reliability of captured data are critical and where that data is provided from a multiplicity of camera sources. The user devices 30 optionally take a form of one or more cameras. Referring to FIG. 7, an image of a scene S is projected via one or more optical components 210 onto an optical sensor 220 such as a CCD or CMOS pixel sensor array, which generates corresponding data D1 depicting the scene S. The data D1 is provided to processing hardware 230 which, when in operation, fragments the data D1, and then applies encryption and obfuscation processes to the fragmented data to generate corresponding obfuscated, encrypted data fragments D2 which are communicated through routers 50 and links 20 to one or more associated user device 30. Obfuscated, encrypted fragments D2 are optionally additionally or alternatively recorded at one or more nodal elements 40 for future reference. For example, images encoded in the data D1 optionally provide legal evidence of a robbery usable in legal trials or legal court cases. As with the user devices 30, the processing hardware 230, when in operation, generates a corresponding parameter file “P” as a part of the fragmenting, obfuscating and encrypting processes. This enables users to monitor remotely their homes, and other property in a confidential manner that is incompatible with third-party eavesdropping.

The system 10 is suitable for providing an alternative to contemporary fiat currency systems and is also capable of being used for handling derivative contracts, namely “derivatives”. When records of derivatives contracts are stored via use of obfuscated encrypted fragments of data in one or more nodal elements 40 of system 10, there is thereby provided a more reliable foundation for performing derivatives transactions. By way of the one or more nodal elements 40 having their data duplicated in a plurality of data storage sites and majority-voting error correction being employed for data stored at one or more nodal elements 40, a very high degree of data storage reliability in the system 10 can be achieved.

The system 10 is optionally managed in order to reduce response times for the user devices 30. Data flow management within the system 10 is implemented in a distributed and/or a centralized manner, as will next be elucidated in greater detail.

In a first manner of operation, when routers 50 and links 20 are implemented pursuant to HTTP IP protocol, for example, data flows via the routers 50 are reported to a control facility of that system 10 that then sends control information to the one or more user devices 30, for enabling them to send their obfuscated encrypted fragments via alternative routers 50 which are less loaded with data flow. Alternatively, in a second manner of operation, data flows via the routers 50 are reported directly to one or more user devices 30 sending data to them for enabling the one or more user devices 30 to select alternative routes to send their obfuscated encrypted fragments. Such an approach beneficially avoids stress points (“bottle necks”) of data flow occurring with the system 10. Optionally, a combination of the first and second manners of operation is employed within the data system 10. Similar considerations also pertain to the one or more nodal elements 40, when they are sending obfuscated encrypted fragments back to the one or more user devices 30. To avoid abuse by third parties desirous to eavesdrop upon the data system 10, routes of data flows of obfuscated encrypted fragments through the routers 50 are optionally monitored and unexpected diversion of obfuscated encrypted fragments are beneficially flagged as a potential eavesdropping event, and one or more alternative data communication routes through the routers 50 and data links 20 are optionally selected to thwart such eavesdropping.

The data system 10 is well adapted for providing video-on-demand by way of use of obfuscated encrypted fragments, representative of video content, present at the one or more nodal elements 40 which are supplied on demand, for example in exchange for consideration, for example one or more payments, from the one or more user devices 30. Such supply of video content is optionally achieved by supplying an appropriate parameter file P to the one or more user devices 30. On receipt of the parameter file P, the one or more user devices 30 retrieve, in operation, appropriate obfuscated, encrypted fragments and reassemble them, in a manner previously elucidated with reference to FIG. 3. In an example, one or more of the obfuscated encrypted fragments are made specific to a given user device 30 that has requested the video content, such that the video content, when reassembled at the given user device 30 is watermarked with one or more visual references which are specific to the given user 30. In an example, the one or more visual references are momentary or otherwise transient, and thus not noticed by viewers, or are overlaid as a subtle watermark, for an extended period of playing of the video content. In an event that the given user makes a copy of the video content, for example as presented on a screen of the given user device 30, or extracted at a software level from screen video driver software of the given user device 30, the watermarking information is also copied and allows the given user, for example a content creator, to be identified from the copies. In an example, additional watermarking information is added at the given user device 30 to that provided in obfuscated encrypted fragments provided from the one or more nodal elements 40 of the data system 10.

Use of the parameter file P provided to the one or more user devices 30 in association with given video content provided via supply of obfuscated encrypted fragments enables the obfuscated encrypted fragments to be sent to nodal elements 40 deployed in a spatially distributed manner, near to the one or more user devices 30; and the associated parameter file P for accessing the block-buster film to be provided to the one or more user devices 30, wherein the obfuscated encrypted fragments are accessed from nodal elements 40 which are connection-wise substantially nearest to each of the one or more user devices 30.

In this arrangement, data traffic within the data system 10, via the communication links 20 and routers 50, is reduced, provided that the user devices 30 are provided substantially with obfuscated encrypted fragments from nodal elements 40 which are spatially closest thereto. In this respect, the parameter files P provided to the user devices 30 are made user-device-specific, depending upon connection positions of the user devices 30 within the data system 10. Use of the parameter file P to enable access to video enables access to the video to be controlled.

The data system 10 facilitates overlay of second data content onto other first data content, for example, when a temporal sequence of video images from a second source are to be overlaid onto a temporal sequence video images from a first source to generate a composite video content. For example, the data system 10 is optionally operable to provide a music performance environment for the user devices 30, and their associated one or more users, wherein a user of a given user device 30 receives a first parameter file P1 to enable obfuscated, encrypted fragments relating to a music backing track to be downloaded to the given user device 30 and reassembled thereat to provide the back track at the given user device 30. In an example, the user of the given device 30 makes a payment for receiving first parameter file P1. In an example, the first parameter file P1 includes identifying information of the given user device 30 which is uniquely present as a form of a watermark in the music backing track. In an example, the identifying information in the parameter file P1 is included in subsequent parameter files, for example in a parameter file P2 which will be described below.

The backing track is played at the given use device 30 concurrently while the given user device 30 is used to record an overlay solo track to overlay temporally onto the backing track to provide a composite music track at the given user device 30. Thereafter, the composite music track is fragmented, encrypted and obfuscated, for example in a manner as depicted in FIG. 2, and stored in the nodal elements 40, and a record is made at one or more of the nodal elements 40 of a parameter file P2 pertaining to the composite music track. In an example, additional tracks may be overlaid onto the composite music track to generate further, more complex, music tracks. In an example, the parameter file P2 includes information indicative of an identity of the backing music track, information indicative of downloading the backing track to the given user device 30, and information indicative of the given user device 30 having overlaid a solo track onto the backing track to generate the composite music track. Thus, by recording the parameter files P1, P2 and any later parameter files PN for further music content with more overlaid music tracks, at a nodal element 40 of data system 10 responsible for royalty payments and copyright enforcement, such a manner of operation of the data system 10 provides for a music environment wherein musicians are able to add their music tracks onto other music tracks, and then publish their composite musical creations. In an example, publication of musical creations optionally returns royalty payments and/or advertising of their musical talent. The data system 10 is capable of being used in a similar manner for video content, pursuant to an embodiment of the present disclosure.

On account of its use of obfuscated encrypted fragments of data files, as well as its data duplication and error correction processes implemented at the one or more nodal elements 40, the data system 10 is capable of providing the confidential and reliable data communication provided by the data system 10 to enables use of the data system 10 for smart grid purposes, as illustrated in FIG. 8. Power generated by one or more generators 310 is coupled via an electrical power grid 300 to one or more consumers 320. In operation, a need arises within the electrical power grid 300 to match power supplied from generators 310 with demand from the one or more consumers 320, for example located in domestic and/or commercial premises. Both a supply of power from the one or more generators 310, and power consumed by the one or more consumers 320 can be potentially temporally highly variable. It will be appreciated that balancing power generation with power demand in respect of a complex electrical power distribution network is not a trivial task. Changing weather conditions influence an amount of power which is generated by renewable energy sources, for example from wind turbines and solar photovoltaic panels. Uranium or MOX solid-fuel nuclear reactors must operate at full power, otherwise build-up of Xenon and Krypton gas on fuel rods at lower fuel rod operating temperatures results in unstable absorption of neutron flux and unstable operation; such instability resulted in the Chernobyl nuclear reactor exploding in year 1986.

Smart electrical meters are often Internet-enabled so that they are capable in operation of sending and receiving information via the Internet®. For example, such smart meters, when in operation, measure cumulative power consumption within a given house, and then send such cumulative power consumption information to an electric supply company for periodic invoicing purposes. Moreover, such a power meter also enables instructions to be received at houses, for performing load shedding when the electrical power grid 300 is heavily overloaded, namely during period of peak power demand. However, such a conventional configuration is potentially susceptible to cyber-attack; for example, an entire national power grid could be potentially destabilized by a cyber-attack, causing a general blackout or brownout by an Internet® virus which affects the smart meters. Embodiments of the present disclosure address sending grid power balancing commands to the one or more consumers 320 by employing data communication via the data system 10 using obfuscated encrypted fragments of data. The data system 10 offers greater security of information regarding power consumption at the one or more consumers 320. When load-shedding commands from a controlling authority responsible for keeping the electrical power grid 300 in power balance are communicated via the data system 10 to the one or more consumers 320, greater security of operation of the electrical power grid 300 is achievable. When employed to send power balancing and load-shedding commands, the data system 10 optionally, when in operation, aggregates consumption information obtained from the one or more consumers 320 in a confidential, reliable manner, to generate aggregated power information. Such aggregated power information is optionally later used to improve a power balance achieved within the electrical power grid 300.

In a similar manner to electric power grid 300 of FIG. 8, the data system 10 optionally finds use as a control for other types of spatially distributed apparatus, as will next be elucidated in greater detail.

In a traffic control system with traffic lights that, when in operation, wirelessly receive control signals from a traffic control center (centre), traffic flow is managed and commands are sent from the traffic control center to the traffic lights via the data system 10. Traffic light control commands are communicated to the traffic lights in an obfuscated, encrypted, fragmented manner to avoid third party tampering. New traffic lights are optionally easily added to the traffic control system, and traffic flows can be readily controlled from the aforesaid traffic control center, for example in emergencies.

In a railway control system with spatially distributed railway signs, level crossing barriers and railway track points wirelessly coupled to a railway control center (centre), data is communicated between the railway control center and the spatially distributed components in an obfuscated, encrypted, fragmented manner to protect data communication confidentiality and data communication robustness within the railway control system.

The data system 10 is susceptible to being employed when a highly robust, confidential and large-data-capacity storage of data is required. For example, the data system 10 is beneficially employed for use with database booking systems used for travel bookings, car hire and stock control; confidential voting systems; digital libraries; and remote schooling for educational establishments.

The data system 10 is susceptible to being employed in connection with network-based computer games, which are played interactively in real-time by a plurality of players that require sharing of data content between a plurality of players. For example, when interactively playing games, data including background video information and playing character symbols and outlines are shared so that each player experiences a consistent game reality. This shared data is optionally provided to the plurality of players in an obfuscated encrypted manner, for example as aforementioned, for example as depicted in FIG. 3. When such interactive gaming is implemented in a network-based computer game, a hosting arrangement at one or more of nodal elements 40 provides one or more parameter files to the plurality of players when a given game is activated and played. When the players receive one or more parameter files, they are able to upload background video information, games software and data fields for recording scoring and are then able to start game play. Data is exchanged, for example shared, between players during game play so that character symbols and outlines move in a mutually coordinated manner. This exchanged data is either communicated directly between one or more user devices 30, and/or is communicated in an obfuscated, encrypted manner referred to in FIG. 2 and FIG. 3. Scores resulting from playing games between the one or more players are optionally stored in an obfuscated, encrypted, fragmented manner in one or more of nodal elements 40, such that a best player performance recorded there optionally invokes payments for outstanding game-playing performance by one or more of the plurality of players.

In other embodiments, the system 10 is susceptible to being used by hospital databases, police databases, relief aid organisations, and/or search engines.

The user devices 30 are optionally implemented, at least in part, as user-wearable devices, for example as arm bands, wrist-worn devices or even incorporated into user clothing. Optionally, the user devices 30 are included on assistance dogs for blind people, so that external assistance can be provided to a given blind person in an event of the blind person's assistance dog encountering a situation where the dog is unable to cope cognitively.

In an example illustrated in FIG. 9, a given user device 30 is implemented as a wireless communication device 400, such as a smart phone, which is operable to communicate with one or more user-wearable devices 410, for example via wireless communication arrangements employing BlueTooth™ or Zigbee™ protocol. When the system 10 is implemented in such a manner, users of the system 10 optionally employ user-wearable devices 410 as multiple sensors distributed over their bodies, allowing, for example, remote sensing and/or recording of health status while maintaining user confidentiality. Moreover, the user device 30 are optionally implemented, wherein such user-wearable devices 410 execute primary data chunking to generate primary data chunks and data obfuscation between the primary data chunks to generate primary, obfuscated data chunks. The wireless communication device 400 optionally receives, when in operation, the primary obfuscated data chunks, and executes secondary data chunking to the primary, obfuscated data chunks to generate secondary data chunks and data obfuscation between the secondary data chunks to generate secondary, obfuscated data chunks for transmission from the wireless communication device 400. Multiple stages of data chunking and obfuscation involve use of a plurality of data maps for use when reconstituting the secondary obfuscated data chunks to regenerate corresponding original data of the one or more user-wearable devices 410; such an approach provides an especially robust defense against malicious third-party eavesdropping, Thus, spatially local eavesdropping of data flows between wireless communication device 400 and the one or more user-wearable devices 410 is, for all practical purposes, prevented. When one or more of the one or more user-wearable devices 410 are configured for cryptocurrency payment, for example, as a wrist band which the given user offers to a payment terminal when making cryptocurrency payment preventing eavesdropping can prevent theft.

In an embodiment, a user-wearable device 410 in the form of a wrist band includes a camera for capturing a short video clip of a given cryptocurrency transaction and the short video clip is recorded remotely, confidentially and securely within the system 10 for subsequent recall as proof that the transaction was made. The user device 30 is optionally implemented as a wireless communication device 400 as described herein, or as a fixed-installation with its associated one or more user-wearable devices 410. As examples, a user-wearable configuration of the system 10 is optionally used by police, emergency services, rescue services, medical services where confidential information collection is necessary to protect user confidentiality and privacy.

In another related aspect of the present disclosure, the system 10 is optionally implemented to provide a decentralized network token exchange system.

When in use, tokens of the token exchange system provide their one or more holders, with perceived economic or social benefit in return for acting out defined and desired actions.

Users are able to contribute to operation of the system 10 by way of, for example, using tokens, as aforementioned. Such tokens are optionally cryptographic tokens of the system 10, wherein the tokens are employed to encourage users and contributors to the system 10. Distribution of tokens is handled entirely by the network, for example on a per use basis. Each token has its own unique identity and is required to access services on the network of the system 10.

In the system 10, tokens are optionally obtained through one or more of computational farming, for example provided as reward for assisting with maintaining underlying code of the system 10, creating software applications for the system 10 and purchasing using a fiat currency such as US dollar, or European Euro.

During aforesaid computational farming, users of the system 10 provide computing resources, such as data communication bandwidth, data storage space and CPU processing capacity to the system 10. For example, when a given user creates his/her credentials, he/she sets up a token wallet within the system 10, with a network client. The wallet is cryptographically linked to the user's account hosted by the system 10. In the system 10, for example, the token farming rate is a result of a network rate, wherein tokens are issued to a successful node, for example a successful and industrious user, as data is retrieved from it (GETS), as opposed to when data is stored there (PUTS).

Optionally, the system 10 increases token farming rewards, in response to increased computing resources being required for operating the system 10, and similarly reduces token farming rewards as capacity of the network becomes abundant. Thus, the farming rate is dynamically variable in response to operating conditions of the system 10. Data is thereby substantially evenly distributed within the network of the system 10, and thus farmers of tokens seeking to increase their earnings optionally consider running several average nodal elements 40, rather than one high-specification node.

As part of such performing token distribution, the system 10 employs a proof of resource process, that validates when in operation, in a continuous manner, who and what is providing resources to the system 10. Such validation is implemented in a mathematically verifiable manner. In other words, such validation is performed during attempts to store data chunks onto and retrieve data chunks from nodal elements 40, respectively. An ability for a given node to be validated to implement such storage and retrieval operations is dependent upon a combination of CPU speed, bandwidth availability, unused data storage capacity and online-time when coupled to communicate with the system 10. In one example embodiment, the system 10 employs a “zero knowledge proof mechanism”, wherein the content of data to be checked need not be known, but the data must be known to be actually held and not subject to data corruption and damage. Nodes 40 that are either unreliable or that are known to be removing previously provided resources, are de-ranked by the network, thereby removing their ability to perform farming of tokens.

Core developers, namely users who are able to develop an underlying network for the system 10, are able to earn aforesaid tokens for their efforts. As core developers create and release new software applications, they code their token wallet address, or addresses, into their software applications, to receive rewards for their efforts. Issuing of tokens is optionally dependent upon, for example, how successful the software applications are for users of the system 10. In an example, a success of a given example software application is optionally determined as a function of a number of user accessing the software applications and/or number of downloads of the software applications.

Beneficially, as aforementioned, the system 10 employs decentralized, peer-to-peer (P2P) exchanges when in operation so as to provide users with an opportunity to buy tokens. Moreover, the exchanges serve as platforms for enabling a given buyer and a given seller to trade mutually directly, using a multi-signature approach. For example, three or more private keys are associated with an address, and a majority of parties holding such private keys must sign to make a given associated transaction valid. Alternatively, or additionally, the system 10 supports, when in operation, centralized exchanges for trading tokens. Such centralized exchanges optionally support conversion of tokens to other types of crypto-currencies; a value of a given token is optionally determined by a market created within an environment of the system 10 for such tokens. Such a market is optionally subject to economic forces of supply and demand.

In an embodiment, the system 10 employs a transaction manager. For token transactions within the system 10, only past and current owners of a given token are known, thus enabling a high degree of anonymity comparable to real, physical fiat currency. A transaction manager may be an entity or role carried out by vaults of the system 10 used to store data pertaining to a given farmer's computer. A vault comprises a series of processes or roles that vary between managing storage of data, managing other vaults and managing processing and completion of token transactions.

In an embodiment of the system 10, the token network reaches decisions based on a consensus of a close group of nodal elements 40, and the transaction manager is a trusted group of nodal elements closest to any given transaction identity. Close groups, are optionally chosen or selected by the system 10 based upon the closeness of node ID's in respect of a given token. Closeness refers, for example, to an XOR distance, or to a geographical distance.

Referring next to FIG. 10, there is provided an illustration of a token transaction mechanism employed within the system 10. One or more transaction managers mediate between a given example user “Alice” and a another given user “Bob” regarding a payment of a quantity of tokens, for example 50 tokens. Four steps are performed by the token transaction mechanism. In a first step S1, a request is sent from Alice to the one or more transaction managers that a 50 token payment to Bob is to be implemented. In a second step S2, the one or more transaction managers generate conditions for a transaction to occur. In a third step S3, transaction information associated with execution of a transaction (namely the payment to Bob) is updated. In a fourth step S4, Bob is notified of the transaction of 50 tokens as having been implemented.

Within the system 10, transfer of data may be atomic, using a cryptographic signature to demonstrate that a last person, for example the user Alice, who owned a given token has signed the given token over to a current owner, for example to the user Bob. When the current owner desires to spend the given token, the current owner asks a network, for example their close group of 32 nodes, to accept a signed message transferring ownership to a subsequent user, namely to a new owner of the given token. Knowledge of ownership of the given token is kept in a plurality close groups, and each group agrees upon and reaches consensus, in operation, on the transfer of ownership of the given token before the transaction of change of ownership of the given token is processed. For example, 28 of 32 nodes must be in mutual agreement to reach a consensus. In such a way, double spending of a given token is beneficially avoided.

In the system 10, generation of tokens, namely “minting” of tokens, is achieved by registering a special type of transaction with the one or more transaction managers. The special type of transaction facilitates transfer of the ownership of a given token to any user that acknowledges the transaction. For example, when the user Alice wants to mint a token, she sends a request to transfer the token to anyone. Once the one or more transaction managers have confirmed by consensus that Alice is the current owner of the given token, they will then generate the transaction, for example, in a manner as depicted in FIG. 10. When Alice receives a transaction name from the network, she is able to store it on a data storage device such as an external data storage device such as a USB drive, together with a special validation signature which has been used as a salt when requesting transfer of the given token. This salt which may be, for example, one or more salt values generated from a salt value generating function, prevents the one or more transaction managers themselves trying to acknowledge the transaction for purposes of attempting to steal the given token.

When the user Bob receives the minted token, he reads the transaction name and the validation signature from the storage device and then sends an acknowledgement to the system 10. Once the one or more transaction managers receive the acknowledgement, the transaction will be updated, thereby completing the transfer of the ownership of the given token from the user Alice to the user Bob. In such a manner of operation, the user Alice does not need to keep her secret key safe, because the transaction is pre-generated. As such, theft of a given private key does not necessarily indicate loss of an associated token.

Tokens of the disclosed implementation of the system 10 are network-led, backed by data, and generated dependent upon retrieval of data from the nodal elements 40, and token transactions can be implemented rapidly in view of the system 10 being implemented electronically.

Tokens can be employed within system 10 for paying for various products and services. For example, tokens can be used to pay for films on a cost-per-frame basis, with a given user only paying for what the given user watches. Similar payment arrangements can be employed for music content and blogging. Token payments may be linked to contemporary copyright laws, so that content creators are compensated for their creative effort.

Token payments are, for example, made by users employing their user-wearable devices compatible with system 10, as described in the foregoing. The user-wearable devices can be used, for example, in supermarkets and shopping malls for point-of-sale when purchasing consumer products (for example, when purchasing foodstuffs) or services (for example, when paying for hairdressing services).

When voting, the data system 10 beneficially employs an asynchronous ordering of votes, in view of parts of the data system 10 functioning in a mutually asynchronous manner when in operation, for example when the data system 10 employs its one or more nodes 40 deployed in a distributed data network, for example in a peer-to-peer (P2P) network. Despite the data system 10 functioning asynchronously, consensus is required to determine whether or not a given element or node of the data system 10 is trustworthy, even when different events in the distributed data network reach various nodes 40 at mutually different times. The data system 10 beneficially implements a data transaction system that combines an asynchronous consensus/node ordering mechanism that functions within a public/non-permissioned network where network members are temporally dynamically changing. Furthermore, the data system 10 is capable of being implemented using an encrypted decentralized data and communications network that utilizes spare computing resources of users of the network. Additionally, the data system 10 can be used within any decentralized network requiring autonomous decision making including: decentralized app development platforms, corporate data networks, crypto currency and financial trading platforms, decentralized applications and gaming. Optionally, the data transaction system combines an asynchronous consensus/node ordering mechanism that functions within a public/non-permissioned network wherein network members are temporally dynamically changing.

As aforementioned, the data system 10, namely the data transaction system, combines an asynchronous consensus/node ordering mechanism that functions within a public/non-permissioned network where network members are dynamic, namely temporally leaving or joining the data system 10. Furthermore, the data system 10 is capable of working within an encrypted decentralized data and communications network that utilizes spare computing resources of users of the network. Additionally, the membership data transaction system can be used within any decentralized network requiring autonomous decision making including: decentralized app development platforms, corporate data networks, crypto currency and financial trading platforms, decentralized applications and gaming.

As aforementioned, the data system 10 employs consensus in its manner of operation. It will be appreciated that the data system 10 implemented in a user-centric manner pursuant to the present disclosure is capable of providing an enhanced degree of data security and robustness. In particular, storing private-key encoded bitcoin information in an obfuscated encrypted manner assists to protect against bitcoin theft. Moreover, transfer of a parameter file “P” is beneficially employed as a manner of transferring bitcoin ownership during financial transactions. Furthermore, a two-stage transfer of a bitcoin via communicating the parameter file “P”, followed by transfer of a password to decrypt the parameter file “P” for accessing a given bitcoin is optionally employed, wherein transfer of the parameter file “P” indicates an intention of a given user to make a financial transaction, for example a purchase of a product, and transfer of the password to decrypt the parameter file “P” corresponds to execution of the financial transaction. In an event that the user or a supplier of the product in the financial transaction default, the supplier is not paid, and the user can be potentially traced from the parameter file “P”, for example via a user-identification portion of the parameter file “P”. Bitcoin can also optionally be employed to make anonymous payments, for example where the user's identity cannot be determined from the parameter file “P”.

The process of financially transacting bitcoins or related cryptocurrency, and other related types of cryptocurrencies, involves a process of passing the bitcoin or related cryptocurrency that preferably alters the signature on the bitcoin to the seller's signature. This new signature is reported back to the bitcoin or related cryptocurrency issuing authority, for example as aforementioned.

Beneficially, the data system 10 employs a fault tolerance algorithm (for example, a Byzantine Fault Tolerance algorithm), namely a feature that mathematically guarantees that all parts of a data communications network involved to supporting its operation of the data system 10 will come to a same agreement (namely, a consensus) at a certain point in time even in the event that some of the nodes are malicious. A Byzantine fault tolerance (BFT) is a measure of a dependability of a fault-tolerant computer system, particularly distributed computing systems such as peer-to-peer networks or diffuse unstructured networks, wherein components potentially fail and there is imperfect information on whether a given component has failed. In an example “Byzantine failure”, a component such as a given server can inconsistently appear both failed and functioning to failure-detection systems of a network, presenting different symptoms to different observers. Subsequently, it is difficult for the other components, for example participating nodes or elements, to declare the given server failed and shut the given server out of the network, because they need firstly to reach a consensus regarding which component has failed; optionally, a consensus is more than 40% of elements agreeing, more optionally more than 50% of elements agreeing, and yet more optionally more than 60% of elements agreeing. Thus, the data system 10 beneficially employs a consensus mechanism for determining unreliable elements, nodes, servers and such like of a given data communication network supporting operation of the data system 10, wherein a decision from the consensus mechanism that a given server, node, router, data memory and so forth is unreliable results in disconnection and isolation of the a given server, node, router, data memory and so forth.

Modifications to embodiments of the disclosure described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

What is claimed is:

1. A data communication system comprising an arrangement of one or more user devices, one or more nodal elements or one or more servers, and/or one or more routers coupled via communication links, the data communication system being configured to:
communicate data in a format having encrypted and obfuscated data chunks defined by one or more data maps;
categorize the one or more user devices, one or more nodal elements or one or more servers, and/or one or more routers into one or more trusted elements and one or more untrusted elements with a trust verification arrangement configured to determine whether a given element is a trusted element or an untrusted element; and
with votes received from the one or more trusted elements, verify one or more transaction events from a consensus computed from asynchronous consensus/node ordering within a public/non-permissioned network in which elements are connecting and/or disconnecting over time.

2. The data communication system of claim 1, wherein the data communication system is further configured to:
with votes received from the one or more trusted elements, verify a reliability of one or more elements of the public/non-permissioned network of the data communication system from a consensus; and
disconnect one or more unreliable elements from the data communication system based upon the verifying.

3. The data communication system of claim 1, further comprising:
a ledger arrangement configured to record transaction events; and
a voting arrangement configured to receive the votes from the trusted elements.

4. The data communication system of claim 3, wherein the ledger arrangement is configured to restrict growth by pruning transaction events over time.

5. The data communication system of claim 1, wherein the data communication system is further configured to:
divide user data into one or more data chunks that are then encrypted and/or obfuscated;
store the one or more encrypted and/or obfuscated data chunks at one or more of the one or more nodal elements or one or more servers;
record locations of the one or more of one or more nodal elements or one or more servers storing the one or more encrypted and/or obfuscated data chunks in at least one of the one or more data maps;
retrieve the one or more stored, encrypted and/or obfuscated data chunks;
decrypt and/or de-obfuscate the data chunks by swapping data there; and
generate the user data by combining the decrypted and/or de-obfuscated data chunks.

6. The data communication system of claim 5, wherein the one or more of the one or more nodal elements or one or more servers storing the one or more encrypted and/or obfuscated data chunks are configured to:
maintain multiple copies of encrypted and/or obfuscated data chunks; and
regenerate from uncorrupted copies of the encrypted and/or obfuscated data chunks one or more replacement encrypted and/or obfuscated data chunks to replace any copy of the encrypted and/or obfuscated data chunks which have been corrupted.

7. The data communication system of claim 1, wherein the data communication system is a publicly-accessible network configured to connect elements thereto and/or disconnect elements therefrom as a function of time.

8. The data communication system of claim 7, wherein the data communication system is further configured to categorize a given element connecting to the publicly-accessible network as an untrusted element until transitioned by the trust verification arrangement into a trusted element of the data communication system.

9. The data communication system of claim 1, wherein the trust verification arrangement is configured to:
determine, from a distributed database:
a speed at which a given element receives information related to transaction events occurring within the data communication system;
accessibility by the given element to information indicative of events associated with transaction events occurring within the data communication system;
a historical performance of the given element at verifying transaction events occurring within the data communication system;
an age of the given element; and
a reputation parameter of the given element relative to other elements of the data communication system.

10. A method for providing secure data communication, comprising:
arranging a data communication system from one or more user devices, one or more nodal elements or one or more servers, and/or one or more routers coupled via communication links;
communicating data within the data communication system in a format including encrypted and obfuscated data chunks defined by one or more data maps; and
categorizing, in accordance with a trust verification arrangements, the one or more user devices, one or more nodal elements or one or more servers, and/or one or more routers into one or more trusted elements and one or more untrusted elements; and
with votes received from the one or more trusted elements, verifying one or more transaction events with a census computed from an asynchronous consensus/node ordering within a public/non-permissioned network in which elements are connecting and/or disconnecting over time.

11. The method of claim 10, further comprising:
with votes received from the one or more trusted elements, verifying a reliability of one or more elements of the public/non-permissioned network of the data communication system from a consensus; and
disconnecting one or more unreliable elements from the data communication system based upon the verifying.

12. The method of claim 10, further comprising:
recording transaction events in a ledger arrangement; and
receiving the votes from the trusted nodes with a voting arrangement.

13. The method of claim 10, further comprising restricting growth of the ledger arrangement by pruning transaction events over time.

14. The method of claim 10, further comprising:
dividing user data into one or more data chunks;
encrypting and/or obfuscating the one or more data chunks; and
storing the one or more encrypted and/or obfuscated data chunks at one or more of the one or more nodal elements or one or more servers; recording locations of the one or more of the one or more nodal elements or one or more servers in at least one data map; and
retrieving the one or more encrypted and/or obfuscated data chunks;
decrypting and/or de-obfuscating the data chunks by swapping data therebetween; and
generating the user data by combining the decrypted and/or de-obfuscated data chunks.

15. The method of claim 14, further comprising:
maintaining multiple copies of the encrypted and/or obfuscated data chunks;
regenerating from uncorrupted copies of the encrypted and/or obfuscated data chunks one or more replacement encrypted and/or obfuscated data chunks to replace any corrupted copy of the encrypted and/or obfuscated data chunks.

16. The method of claim 10, wherein arranging a data communication system further comprises arranging the data communication system as a publicly-accessible network configured to connect elements thereto and disconnect elements therefrom as a function of time.

17. The method of claim 16, further comprising categorizing a given element connecting to the publicly-accessible network as an untrusted element until transitioned by the trust verification arrangement into a trusted element.

18. The method of claim 10, further comprising:
from a distributed database, determining:
a speed at which a given element receives information related to transaction events occurring within the data communication system;
accessibility by the given element to information indicative of events associated with transaction events occurring within the data communication system;
a historical performance of the given element at verifying transaction events occurring within the data communication system;
an age of the given element; and
a reputation of the given element relative to other elements of the data communication system.

19. A computer program product comprising a non-transitory computer-readable storage medium having computer-readable instructions stored thereon, the computer-readable instructions being executable by a data communication system arranged from one or more user devices, one or more nodal elements or one or more servers, and/or one or more routers coupled via communication links, to:
communicate data in a format comprising encrypted and obfuscated data chunks defined by one or more data maps;
categorize the one or more user devices, one or more nodal elements or one or more servers, and/or one or more routers into one or more trusted elements and one or more untrusted elements with a trust verification arrangement configured to determine whether a given element is a trusted element or an untrusted element; and
with votes received from the one or more trusted elements, verify one or more transaction events with a census computed from an asynchronous consensus/node ordering within a public/non-permissioned network in which elements are connecting and/or disconnecting over time.

20. The computer program product of claim 19, wherein the computer-readable instructions are further executable to:
record transaction events using a leger arrangement, and
receive the votes with a voting arrangement.

21. The computer program product of claim 19, wherein the computer-readable instructions are further executable to restrict growth of the ledger arrangement by pruning transaction events over time:

22. The computer program product of claim 19, wherein the computer-readable instructions are further executable to:
divide user data into one or more data chunks;
encrypt and/or obfuscate the data chunks; and
store the one or more encrypted and/or obfuscated data chunks at one or more of the one or more nodal elements or one or more servers;
record, in one of the one or more data maps, locations of the one or more of the one or more nodal elements or one or more servers;
retrieve the one or more encrypted and/or obfuscated data chunks at the one or more nodal elements or one or more servers;
decrypt and/or de-obfuscate the data chunks by swapping data therebetween; and
generate user data by combining the decrypted and/or de-obfuscated data chunks.

23. The computer program product of claim 19, wherein the computer-readable instructions are further executable to:
maintain multiple copies of the one or more encrypted and/or obfuscated data chunks;
regenerate from uncorrupted copies of the one or more encrypted and/or obfuscated data chunks one or more replacement encrypted and/or obfuscated data chunks to replace any corrupted copy of the one or more encrypted and/or obfuscated data chunks.

24. The computer program product of claim 19, wherein the computer-readable instructions are further executable to, in a publicly-accessible network, connect elements to and/or disconnect elements from the publicly-accessible network as a function of time.

25. The computer program product of claim 23, wherein the computer-readable instructions are further executable to categorize a given element connecting to the publicly-accessible network as an untrusted element until transitioned by the trust verification arrangement to a trusted.

26. The computer program product of claim 19, wherein the computer-readable instructions are further executable to, with the trust verification arrangement:
determine, from a distributed database:
a speed at which a given element receives information related to transaction events occurring within the data communication system;
accessibility by the given element to information indicative of events associated with transaction events occurring within the data communication system;
a historical performance of the given element at verifying transaction events occurring within the data communication system;
an age of the given element; and
a reputation parameter of the given element relative to other elements of the data communication system.
